(19) United States
(12) Patent Application Publication
(10) Pub. No.: US 2026/0084828 A1
(43) Pub. Date: Mar. 26, 2026

(54) Method and device for allocating sustainable aviation fuel to a plurality of flights

(71) Applicant: THALES, Meudon (FR)

(72) Inventors: Guillaume PABIA, MERIGNAC (FR); Damien GOUBINAT, TOULOUSE (FR); Chris DESEURE, TOULOUSE (FR)

(21) Appl. No.: 19/328,128

(22) Filed: Sep. 13, 2025

(30) Foreign Application Priority Data
Sep. 20, 2024 (FR) 2410036

(51) Int. Cl. B64D 37/00

(52) U.S. Cl. CPC B64D 37/00

(57) ABSTRACT

A method for allocating sustainable aviation fuel to a plurality of flights, including the following operations, collection of flight data acquiring, for each flight, at least a pair of data formed by information representative of the departure airport and information representative of the arrival airport, from the collected data and a predetermined climate metric, obtaining an estimated score representative of the estimated climate impact of each flight covering both CO₂ emissions and non-CO₂ effects, from the set of estimated scores, determining the allocation of sustainable aviation fuel, associated with the maximum reduction of the estimated climate impact of the totality of flights of the plurality, and allocating to each flight an elementary quantity of sustainable aviation fuel.

### REFERENCE TO RELATED APPLICATIONS

This application is a U.S. non-provisional application claiming the benefit of French Patent Application No. 24 10036 filed on Sep. 20, 2024, the contents of which are incorporated herein by reference in their entirety.

### TECHNICAL FIELD OF THE INVENTION

This invention relates to a method for allocating sustainable aviation fuel to a plurality of flights.

The invention also relates to a computer program including software instructions that, when executed by a computer, implement such a method.

The invention also relates to an electronic device for allocating sustainable aviation fuel to a plurality of flights.

The invention is in the field of aeronautics, specifically in optimizing aviation operations to reduce the associated environmental footprint, with climate change being a current issue.

### BACKGROUND OF THE INVENTION

Until now, the aeronautics sector has focused heavily on carbon dioxide CO₂ emissions, but recent studies have shown that CO₂ is not the only consequence of aviation operations, as non-CO₂ effects account for more than half of the radiative forcing from the sector, with a figure of 66% notably indicated in the article by Lee et al. titled “The contribution of global aviation to anthropogenic climate forcing for 2000 to 2018” with uncertainties of around +/−50 mW/m².

Indeed, emissions from fuel combustion may be classified into two categories: primary jet fuel combustion products like carbon dioxide CO₂, water, sulfur oxides SOx (SO₂, SO₃), which are the direct result of combustion and thus have a constant emission index. This means the amount of gas emitted is proportional to the amount of fuel consumed (this proportionality factor being constant).

The second category corresponds to secondary jet fuel combustion products like nitrogen oxides NOx (Nitric oxide NO, nitrogen dioxide NO₂, nitrous oxide, etc.), carbon monoxide CO, HC (Unburnt Hydrocarbons), PM (Particular Matter), or VOC (Volatile Organic Compounds), which depend on the nature of the combustion process and the load demanded from the engine. They thus have an emission index that varies during the flight depending on the engine type, operating conditions, and atmospheric conditions.

Non-CO₂ emissions are associated with various non-CO₂ effects, such as aerosol-cloud interactions, aerosol-radiation interactions, stratospheric water vapor, the aforementioned nitrogen oxides, emissions associated with contrails, and also nitrogen oxides being the non-CO₂ emissions with the most significant radiative forcing.

The radiative forcing of air transport has been estimated at about 6 to 7% of global anthropogenic radiative forcing, integrating both CO₂ and non-CO₂ effects (2 to 3% integrating only CO₂ effects).

The aviation industry has already made significant scientific progress to improve the environmental efficiency of a flight in terms of weight reduction, aerodynamics, and propulsion. Despite this, emissions from the aviation sector are increasing due to traffic growth estimated at more than 3.6% per year.

For the aviation sector to achieve true zero aviation, the reduction of CO₂ emissions must be complemented by those of non-CO₂ effects.

Sustainable aviation fuel SAF is currently one of the solutions proposed by the aviation industry to take action on decarbonizing the sector.

Sustainable aviation fuels SAFs are used as a substitute for the conventional kerosene used in aviation, such as Jet A-1. The production of sustainable aviation fuel SAF relies on carbon capture, notably through biomass or cooking oils, for example.

The combustion of sustainable aviation fuel SAF thus has a CO₂ emission reduction effect related to the CO₂ that has already been sequestered. Sustainable aviation fuels SAFs thus allow for a significant reduction in CO₂ emissions while also having a strong impact on non-CO₂ effects from aviation like nitrogen oxides NOx, and particularly on contrails.

Indeed, contrails generated by sustainable aviation fuel SAF or blends of sustainable aviation fuel SAF and conventional kerosene have different physical properties because they are made up of finer particles (i.e., smaller in size) but more numerous, and consequently have reduced opacity and also remain in the atmosphere for less time (i.e., reduced lifespan), so they have a reduced impact in terms of CO₂ equivalent.

Thus, while it is desirable for an aircraft to avoid generating a contrail, generating a contrail using sustainable aviation fuel SAF is less harmful to the climate than if it had been generated by conventional kerosene.

However, sustainable aviation fuel SAF is currently a scarce resource, available only at a few airports and in quantities often extremely limited compared to the growing demand of the industry. The quantity of sustainable aviation fuel SAF is currently very limited, making it impossible for each aircraft to have sustainable aviation fuel SAF at the maximum content provided by engine manufacturers, i.e., up to 50% without engine or combustion system modifications.

When available at an airport, sustainable aviation fuel SAF is currently allocated homogeneously across the available fleet. For example, it is decided that a quantity of sustainable aviation fuel SAF is distributed uniformly among all flights within a defined time period, for example, all flights in a day departing between 8 am and 11 am will fly with a SAF quantity equal to 2% of their total fuel.

As an alternative, sustainable aviation fuel SAF is allocated in an unknown proportion within the tanks, its benefit in terms of CO₂ reduction being granted, depending on the quantity purchased, to the purchasing entity of the sustainable aviation fuel SAF, such as the aircraft operator, an airport, or any other entity managing multiple aircraft or sites.

In other words, no current allocation of SAF seems to be being implemented intelligently.

### SUMMARY OF THE INVENTION

Given such scarcity and the effectiveness of sustainable aviation fuel SAF in reducing CO₂ emissions as well as non-CO₂ effects, the aim of the invention is to provide a solution for optimally allocating such sustainable aviation fuel.

To this end, the invention includes a method for allocating sustainable aviation fuel to a plurality of flights planned over a predetermined time interval, the method being implemented by an electronic device, and including at least the following operations implemented prior to the departure of the plurality of flights:
collection of flight data acquiring, for each flight, at least a pair of data formed by information representative of the departure airport and information representative of the arrival airport of the flight;
from the collected data and a predetermined climate metric, obtaining an estimated score representative of the estimated climate impact of each flight of the plurality of flights, the estimated climate impact covering both the CO₂ emissions of the flight and the non-CO₂ effects associated with the flight;
from the set of estimated scores of each flight of the plurality of flights, determining the allocation of sustainable aviation fuel, associated with the maximum reduction of the estimated climate impact of the totality of flights of the plurality, the allocation allocating to each flight an elementary quantity of sustainable aviation fuel to be used during the flight.

Thus, this invention proposes a solution to determine the best possible allocation of sustainable aviation fuel SAF to a plurality of flights considered based on the overall climate impact of this allocation, ensuring that the small quantity of sustainable aviation fuel SAF currently available is allocated to flights whose resulting impact reduction, in terms of CO₂ emissions and advantageously non-CO₂ effects, is the most advantageous.

The allocation determined according to the present invention is thus intelligent, as it prioritizes the use of sustainable aviation fuel SAF for flights whose climate impact is most likely to be reduced by such use, and dynamic (i.e., likely to vary), as it adapts to each considered plurality of flights.

According to other advantageous aspects of the invention, the method includes one or more of the following features, taken individually or in any technically possible combination:
the collection of flight data acquires, for each flight, in addition to the pair of data, at least one element belonging to the group including at least:
   the type of aircraft operating the considered flight;
   the engine of the aircraft operating the considered flight;
   the planned departure time and day of the considered flight;
   the trajectory and/or the planned flight plan for the flight;
   at least one forecasted weather data on the trajectory of the type belonging to the group including at least:
   a humidity data;
   a temperature data;
   a wind data;
obtaining an estimated score representative of the climate impact of each flight of the plurality of flights includes successively at least:
determining at least one value belonging to the group including at least:
   the amount of carbon dioxide from the CO₂ emissions of the flight;
   the amount of equivalent carbon dioxide associated with at least one persistent contrail of the flight;
   the distance over which at least one persistent contrail of the flight is likely to form;
   a function representative of the climate impact over time along the trajectory of the flight of at least one persistent contrail likely to form during the flight;
      determining at least one estimated score element belonging to the group including:
         the ratio of the amount of equivalent carbon dioxide associated with at least one persistent contrail of the flight to the amount of carbon dioxide from the CO₂ emissions of the flight;
         the ratio of the distance over which at least one persistent contrail of the flight is likely to form to the total distance likely to be covered during the flight;
         an estimated score element obtained from the function representative of the climate impact over time along the trajectory of the flight of at least one persistent contrail likely to form during the flight using the amplitude and timing of impact peaks represented via the function;
         in case of determining at least two estimated score elements, combining according to a predetermined rule the at least two estimated score elements to obtain the estimated score;
determining the allocation of sustainable aviation fuel uses linear programming optimization with an objective of maximizing the reduction of the climate impact of the totality of flights of the plurality, and respecting at least one predetermined constraint of availability and use of sustainable aviation fuel;
the at least one constraint belongs to the group including at least one of the following three constraints:
   the sum of the elementary quantities of sustainable aviation fuel allocated respectively to each flight of the plurality is less than or equal to the total quantity of sustainable aviation fuel available for the plurality;
   for each flight to which an elementary quantity of sustainable aviation fuel is allocated, the percentage of the elementary quantity relative to the total quantity of fuel required for the flight is less than or equal to a predetermined percentage value;
   the sum of the elementary quantities of sustainable aviation fuel allocated respectively to each flight of a set of flights of the plurality associated with the same departure airport is less than or equal to the total quantity of sustainable aviation fuel available at the departure airport for the set of flights;
the method further includes a verification operation, after the effective implementation of the plurality of flights, of the effectiveness of the allocation;
the verification operation includes the following sub-operations implemented after the arrival of the plurality of flights:
   collection of effective flight data acquiring, for each flight, at least data of at least one type belonging to the group including at least:
   radar data of the performed trajectory;
   raw flight data provided by a quick access recorder;
   meteorological data representative of the weather conditions encountered during the flight;
   from the collected effective data, the allocation and the predetermined climate metric, obtaining an effective score representative of the effective climate impact of each flight of the plurality of flights, the effective climate impact covering both the CO₂ emissions of the flight and the non-CO₂ effects associated with the flight performed using the sustainable aviation fuel allocated according to the allocation;
   from the set of effective scores of each flight of the plurality of flights, determining the effective reduction of climate impact obtained via the allocation;
   comparing the effective reduction to the maximum estimated reduction during the determination of the allocation, and in the presence of a discrepancy, restitution of the discrepancy;
   the predetermined climate metric is likely to be selected in advance from a list including at least the following metrics:
   GWP20;
   GWP50;
   GWP100;
   ATR20;
   ATR50;
   ATR100;
   GTP20 or AGTP20;
   GTP50 or AGTP50;
   GTP100 or AGTP100;
   EF or RF.

The invention also relates to a computer program including software instructions that, when executed by a computer, implement a method for allocating sustainable aviation fuel to a plurality of flights as defined above.

The invention also includes an electronic device for allocating sustainable aviation fuel to a plurality of flights planned over a predetermined time interval, the electronic device including at least:
a collection module configured to collect flight data and acquire, for each flight, at least a pair of data formed by information representative of the departure airport and information representative of the arrival airport of the flight;
an obtaining module configured to obtain, from the collected data and a predetermined climate metric, a score representative of the climate impact of each flight of the plurality of flights, the climate impact covering both the CO₂ emissions of the flight and the non-CO₂ effects associated with the flight;
a determination module configured to determine, from the set of scores of each flight of the plurality of flights, the allocation of sustainable aviation fuel associated with the maximum reduction of the climate impact of the totality of flights of the plurality, the allocation allocating to each flight an elementary quantity of sustainable aviation fuel to be used during the flight.

### BRIEF DESCRIPTION OF THE DRAWINGS

The invention will become clearer upon reading the following description, given solely by way of non-limiting example, and made with reference to the drawings wherein:

FIG. 1 is a schematic representation of an electronic device for allocating sustainable aviation fuel to a plurality of flights planned over a predetermined time interval, according to the present invention; and

FIG. 2 is a flowchart of the main operations of a method for allocating sustainable aviation fuel to a plurality of flights planned over a predetermined time interval, according to the present invention.

### DETAILED DESCRIPTION OF THE INVENTION

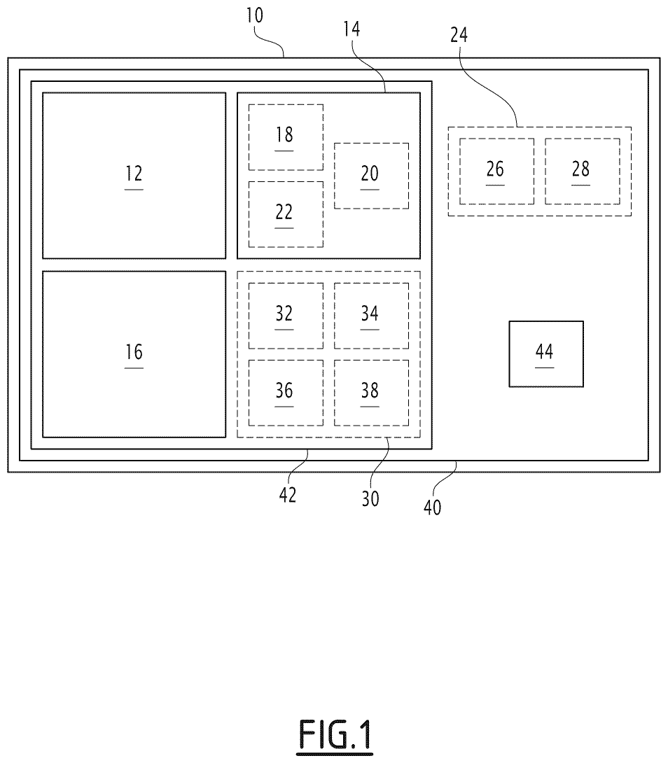

FIG. 1 illustrates an embodiment of an electronic device 10 for allocating sustainable aviation fuel to a plurality of flights planned over a predetermined time interval, according to the present invention.

The electronic device 10 first includes a collection module 12 configured to collect flight data and acquire, for each flight, at least a pair of data formed by information representative of the departure airport and information representative of the arrival airport of the flight.

Optionally, the collection module 12 is also configured to collect additional data from the pair of data, including at least one element belonging to the group including at least:
the type of aircraft operating the considered flight;
the engine of the aircraft operating the considered flight;
the planned departure time and day of the considered flight;
the trajectory and/or the planned flight plan for the flight;
at least one forecasted weather data on the trajectory of the type belonging to the group including at least:
   a humidity data;
   a temperature data;
   a wind data.

The electronic device 10 further includes:
an obtaining module 14 configured to obtain, from the collected data and a predetermined climate metric, a score representative of the climate impact of each flight of the plurality of flights, the climate impact covering both the CO₂ emissions of the flight and the non-CO₂ effects associated with the flight, and
a determination module 16 configured to determine, from the set of scores of each flight of the plurality of flights, the allocation of sustainable aviation fuel associated with the maximum reduction of the climate impact of the totality of flights of the plurality, the allocation allocating to each flight an elementary quantity of sustainable aviation fuel to be used during the flight.

Optionally (represented in dotted lines), the obtaining module 14 includes a first determination tool 18 configured to determine at least one value belonging to the group including at least:
the amount of carbon dioxide from the CO₂ emissions of the flight;
the amount of equivalent carbon dioxide associated with at least one persistent contrail of the flight;
the distance over which at least one persistent contrail of the flight is likely to form;
a function representative of the climate impact, over time, along the trajectory of the flight, of at least one persistent contrail likely to form during the flight.

According to a particular variant, the first determination tool 18 uses at least one of the determination elements belonging to the group of determination elements including:
a modeling tool for the formation and evolution of contrails and cirrus, such as CoCip (Contrail Cirrus Prediction tool);
predetermined algorithmic climate change functions, such as aCCF (algorithmic Climate Change Function);
at least one statistical average of previously stored historical data.

Note that, depending on the first determination tool 18 according to this particular variant, during the collection operation 52, it is necessary to obtain additional input meteorological data.

For example, if the aforementioned CoCip tool is used, the necessary input meteorological data are listed on page 33 of the document by Teoh et al. titled “Flight trajectories, aircraft performance end emissions”.

Different input meteorological data from those required by the CoCip tool are necessary for the aCCF functions, a list of which is notably indicated in the sub-section titled “Download Wx data from ECMWF” of the document available via the following URL: https://py.contrails.org/integrations/ACCF.html.

According to this optional complement, the obtaining module 14 also includes a second determination tool 20 configured to determine at least one estimated score element belonging to the group including:
the ratio of the amount of equivalent carbon dioxide associated with at least one persistent contrail of the flight to the amount of carbon dioxide from the CO₂ emissions of the flight;
the ratio of the distance over which at least one persistent contrail of the flight is likely to form to the total distance likely to be covered during the flight;
an estimated score element obtained from the function representative of the climate impact, over time, along the trajectory of the flight, of at least one persistent contrail likely to form during the flight using the amplitude and timing of impact peaks represented via the function.

According to this optional complement, the obtaining module 14 also includes a combination tool 22, in case of determination by tool 20 of at least two estimated score elements, configured to combine according to a predetermined rule the at least two estimated score elements to obtain the estimated score.

Optionally, the predetermined climate metric is likely to be selected in advance from a list including at least the following metrics:
GWP20 (Global Warning Potential over 20 years);
GWP50 (Global Warning Potential over 50 years);
GWP100 (Global Warning Potential over 100 years);
ATR20 (Average Temperature Response aggregated over 20 years);
ATR50 (Average Temperature Response aggregated over 50 years);
ATR100 (Average Temperature Response aggregated over 100 years);
AGTP20 or GTP20 (Absolute Global Temperature Change Potential over 20 years and Global Temperature Change Potential over 20 years);
AGTP50 or GTP50 (Absolute Global Temperature Change Potential over 50 years and Global Temperature Change Potential over 50 years);
AGTP100 or GTP100 (Absolute Global Temperature Change Potential over 100 years and Global Temperature Change Potential over 100 years);
EF (Energy Forcing) or RF (Radiative Forcing),
or any other known climate metric, such as notably cited and explained by Borella et al. in their article titled “The importance of an informed choice of CO2-equivalence metrics for contrail avoidance”.

Optionally, the determination module 16 of the allocation of sustainable aviation fuel is configured to implement linear programming optimization, the linear programming optimization having an objective of maximizing the reduction of the climate impact of the totality of flights of the plurality, and respecting at least one predetermined constraint of availability and use of sustainable aviation fuel.

According to this optional complement, the at least one constraint belongs to the group including at least one of the following three constraints:
the sum of the elementary quantities of sustainable aviation fuel allocated respectively to each flight of the plurality is less than or equal to the total quantity of sustainable aviation fuel available for the plurality;
for each flight to which an elementary quantity of sustainable aviation fuel is allocated, the percentage of the elementary quantity relative to the total quantity of fuel required for the flight is less than or equal to a predetermined percentage value;
the sum of the elementary quantities of sustainable aviation fuel allocated respectively to each flight of a set of flights of the plurality associated with the same departure airport is less than or equal to the total quantity of sustainable aviation fuel available at the departure airport for the set of flights.

Optionally, as represented in dotted lines in FIG. 1, the electronic device 10 for allocating sustainable aviation fuel to a plurality of flights planned over a predetermined time interval also includes a restitution module 24 of the fuel allocation determined by module 16. Such a restitution module 24 is configured to restitute, to at least one flight operator or to at least one controller of fuel distribution within a departure airport of at least one of the flights of the plurality, or even to personnel belonging to an airline or oil company, the elementary quantity of sustainable aviation fuel SAF allocated to each flight according to the allocation. For example, the predetermined time interval allows all flights of a day departing between 8 am and 11 am, or even all flights between 2 pm and 10 pm, etc., to be selected.

To do this, the module 24 optionally includes a transmission tool 26 configured to transmit, for example, via wireless radio communication, to each flight operator, or to each person in charge of refueling with sustainable aviation fuel SAF the elementary quantity of sustainable aviation fuel SAF allocated to each flight according to the allocation, and/or a display or sound restitution tool 28 configured to indicate to each flight operator, or to each person in charge of refueling with sustainable aviation fuel SAF, the elementary quantity of sustainable aviation fuel SAF allocated to each flight according to the allocation.

Optionally, as illustrated in dotted lines in FIG. 1, the electronic device 10 for allocating sustainable aviation fuel to a plurality of flights planned over a predetermined time interval also includes a verification module 30 configured to verify, after the effective implementation of the plurality of flights, the effectiveness of the allocation that was applied during the effective implementation of the plurality of flights.

According to this optional complement, the verification module 30 notably includes a collection tool 32 configured to collect the effective flight data by acquiring, for each flight, at least data of at least one type belonging to the group including at least:
radar data of the performed trajectory;
raw flight data provided by a quick access recorder;
meteorological data representative of the weather conditions encountered during the flight.

According to this optional complement, the verification module 30 further includes, for example, an obtaining tool 34 configured to obtain, from the collected effective data, the allocation and the predetermined climate metric, an effective score representative of the effective climate impact of each flight of the plurality of flights, the effective climate impact covering both the CO₂ emissions of the flight and the non-CO₂ effects associated with the flight performed using the sustainable aviation fuel allocated according to the allocation.

According to this optional complement, the verification module 30 further includes, for example, a determination tool 36 configured to determine, from the set of effective scores of each flight of the plurality of flights, the effective reduction of climate impact obtained via the allocation.

According to this optional complement, the verification module 30 further includes, for example, a comparison tool 38, configured to compare the effective reduction to the maximum estimated reduction during the determination of the allocation, and in the presence of a discrepancy, provide the discrepancy, notably via the optional restitution module 24 previously described.

In the example of FIG. 1, the electronic device for allocating sustainable aviation fuel to a plurality of flights planned over a predetermined time interval includes an information processing unit 40 formed, for example, of a memory 42 and a processor 44 associated with the memory 42.

In the example of FIG. 1, the collection module 12, the obtaining module 14, the determination module 16, as well as optionally the restitution module 24 and the verification module 30, are each implemented in the form of software, or a software brick, executable by the processor 44. The memory 42 of the electronic device for allocating sustainable aviation fuel to a plurality of flights planned over a predetermined time interval is then able to store collection software, obtaining software, determination software, as well as optionally restitution software and verification software. The processor 44 is then able to execute each of the software among the collection software, obtaining software, determination software, as well as optionally restitution software and verification software.

Alternatively, as illustrated in the example of FIG. 1, the collection module 12, the obtaining module 14, the determination module 16, as well as optionally the restitution module 24 and the verification module 30, are each implemented in the form of software, and the restitution module 24 is not implemented in software form but in the form of an electronic module.

In an unrepresented variant, the collection module 12, the obtaining module 14, the determination module 16, as well as optionally the restitution module 24 and the verification module 30, are each implemented in the form of a programmable logic component, such as an FPGA (Field Programmable Gate Array), or even an integrated circuit, such as an ASIC (Application Specific Integrated Circuit).

When the electronic device 10 for allocating sustainable aviation fuel to a plurality of flights planned over a predetermined time interval is implemented in the form of one or more software, i.e., in the form of a computer program, also called a computer program product, it is also able to be recorded on a medium, not represented, readable by a computer. The computer-readable medium is, for example, a medium able to store electronic instructions and to be coupled to a bus of a computer system. For example, the readable medium is an optical disk, a magneto-optical disk, a ROM memory, a RAM memory, any type of non-volatile memory (for example, FLASH or NVRAM) or a magnetic card. A computer program including software instructions is then stored on the readable medium.

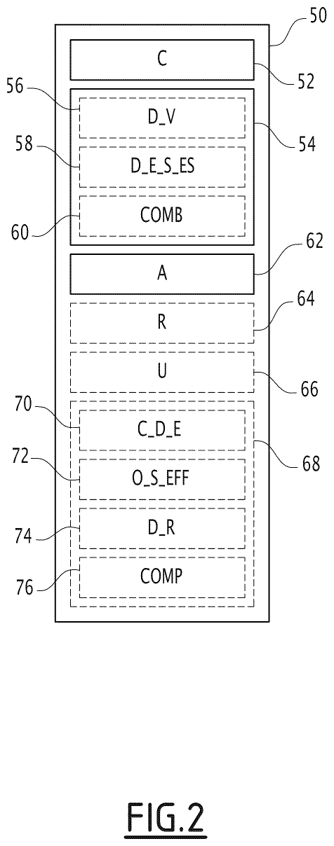

We now describe below in relation to FIG. 2 an example of operation of the electronic device 10 for allocating sustainable aviation fuel to a plurality of flights planned over a predetermined time interval.

More precisely, according to the embodiment of the present invention illustrated by FIG. 2, the method 50 for allocating sustainable aviation fuel to a plurality of flights planned over a predetermined time interval includes a first operation 52 of collecting C flight data acquiring, for each flight, at least a pair of data formed by information representative of the departure airport and information representative of the arrival airport of the flight; such information corresponds, for example, to a pair coupling two cities, namely the departure city and the arrival city (city pair), such as, for example, the pair “PARIS-NYC” to represent a flight between Paris and New York City.

Optionally, the collection 52 of flight data acquires, for each flight, in addition to the pair of data, at least one element belonging to the group including at least:
the type of aircraft operating the considered flight (for example, an Airbus A320 aircraft, a Boeing 737, an Airbus A350, an Embraer 190, etc.);
the engine of the aircraft operating the considered flight (for example, a CFM56-5B4 engine, a LEAP-1B28 engine, a GEnx-1B70/P2 engine, the engine database of the International Civil Aviation Organization ICAO, available via the following URL: https://www.easa.europa.eu/en/domains/environment/licao-aircraft-engine-emissions-databank also providing a list of existing engines, and in the case where the engine identification is not available, a default engine is likely to be used corresponding, for example, to the most common engine for the type of aircraft operating the considered flight);
the planned departure time and day of the considered flight;
the trajectory and/or the planned flight plan for the flight, for example, in the form of a set of points defined in four dimensions, namely three spatial dimensions according to the coordinates (x, y, z) of a predetermined reference frame and a temporal dimension indicating the time t associated with the point of the trajectory;
at least one forecasted weather data on the trajectory (i.e., the trajectory of the city pair) of the type belonging to the group including at least:
a humidity data;
a temperature data;
a wind data.

Then, the method 50 according to the present invention includes an operation 54 of obtaining, from the collected data and a predetermined climate metric, an estimated score representative of the estimated climate impact of each flight of the plurality of flights, the estimated climate impact covering both the CO₂ emissions of the flight and the non-CO₂ effects associated with the flight.

In other words, the obtaining operation 54 allows evaluation, in the form of a score Bj, of the climate impact of each flight j of the plurality, notably selected via a predetermined time interval, to identify those as being the most suitable to operate with a kerosene-SAF mix given their CO₂ and non-CO₂ balance.

Optionally, the predetermined climate metric is likely to be selected in advance from a list including at least the following metrics:
GWP20 (Global Warning Potential over 20 years);
GWP50 (Global Warning Potential over 50 years);
GWP100 (Global Warning Potential over 100 years);
ATR20 (Average Temperature Response aggregated over 20 years);
ATR50 (Average Temperature Response aggregated over 50 years);
ATR100 (Average Temperature Response aggregated over 100 years);
AGTP20 or GTP20 (Absolute Global Temperature Change Potential over 20 years and Global Temperature Change Potential over 20 years);
AGTP50 or GTP50 (Absolute Global Temperature Change Potential over 50 years and Global Temperature Change Potential over 50 years);
AGTP100 or GTP100 (Absolute Global Temperature Change Potential over 100 years and Global Temperature Change Potential over 100 years);
EF (Energy Forcing) or RF (Radiative Forcing),
or any other known climate metric, such as notably cited and explained by Borella et al. in their article titled “The importance of an informed choice of CO2-equivalence metrics for contrail avoidance”.

According to an optional variant represented in dotted lines, the obtaining 54 of an estimated score representative of the climate impact of each flight of the plurality of flights includes successively at least three sub-operations 56, 58, and 60. In other words, according to this optional variant, for each flight of the plurality, the sub-operations 56, 58, and 60 are carried out using the data previously collected during operation 52 (flight data, meteorological data, etc.).

The first sub-operation 56 is the determination D_V of at least one value belonging to the group including at least:
the amount of carbon dioxide from the CO₂ emissions of the flight;
the amount of equivalent carbon dioxide associated with at least one persistent contrail of the flight;
the distance over which at least one persistent contrail of the flight is likely to form;
a function representative of the climate impact, over time, along the trajectory of the flight, of at least one persistent contrail likely to form during the flight.

According to a first variant, the calculation of CO₂ emissions due to fuel is carried out using a constant multiplier coefficient, such as: EICO2=3.16 kg_{CO2}/kg_{fuel} set by the International Civil Aviation Organization (ICAO), such as CO₂=3.16*Qt_{f}) with Qt_{f} being the amount of fuel burned as used in the ICAO Environmental Report 2022 and in the ICAO Carbon Emissions Calculator Methodology. In other words, the factor 3.16 is a factor based on the standard estimation of fuel conversion to CO₂.

According to a second variant, in the case where the mass of fuel (i.e., fuel, kerosene, jet fuel, etc.) likely to be consumed during the considered flight is not available, it is still possible to estimate the amount of CO₂ emitted even if the accuracy may be lower, using aircraft performance models (OpenAP®—open aircraft performance model available via the following URL: https://openap.dev/), a Poll-Schumann PS Model as described by Poll et al. in the document titled: “An estimation method for the fuel burn and other performance characteristics of civil transport aircraft in the cruise. Part 1 fundamental quantities and governing relations for a general atmosphere”, BADA® (Base of Aircraft data), etc.) associated with the trajectory and meteorological data of the considered flight, or relying on historical data, such as similar past flights or averages of similar flights (based on the same departure and arrival airport and the same type of aircraft and possibly the same engine type).

For the determination of the amount of equivalent carbon dioxide associated with at least one persistent contrail of the flight, a climate model, such as, for example, the modeling tool for the formation and evolution of contrails and cirrus CoCiP (Contrail Cirrus Prediction tool) is used to calculate the impacts of contrails. This model takes into account flight data and weather conditions, referred to as “weather-based models” as opposed to “location-based models” that do not take into account the weather of the day as described later).

Such a CoCiP tool is notably able to provide a “CO2eq (contrails)” variable whose value is equal to the CO2 equivalent of the contrails of each considered flight of the plurality based on the chosen climate metric (for example, GWP100 as indicated in the previously listed climate metrics), or even a “Contrail distance” variable whose value is equal to the distance over which contrails form for each flight of the plurality, or even a “Contrail impact over time” function representative of the climate impact of contrails, over time, along the trajectory of at least one persistent contrail likely to form during the flight.

In particular, for the “CO2eq (contrails)” variable, the CoCiP tool provides a prediction of the energy forcing in Joules, caused by the contrails generated by the flight, and it is easy to convert a value in Joules (Energy Forcing) to the different metrics (GWP100, for example) notably as described in the document accessible via the following link: https://apidocs.contrails.org/ef-interpretation.html.

The use of climate models, such as the aforementioned CoCiP modeling tool as an example, to calculate the impact of non-CO₂ effects and more particularly contrails requires a lot of meteorological and flight data. In cases where some of these data are missing, workarounds are available to still evaluate the climate impact of a flight, notably via:
the use of a location-based model, using notably predetermined algorithmic climate change functions, such as aCCF (algorithmic Climate Change Function), which takes as input, for each flight of the plurality, only the trajectory and the fuel consumed along this trajectory, this model providing results in Kelvin, and using a climate metric ATR (ATR20, ATR50, or even ATR100 as previously listed with ATR being the average temperature response), which allows the average temperature changes caused by the considered flight to be characterized;
historical data, such as similar past flights or averages of similar flights. In this case, and unlike the use of “weather-based models” or even “location-based models”, the similar flights associated with the historical data are defined with a predetermined degree of precision. Indeed, given the impact of weather on non-CO₂ effects and particularly on contrails, we will seek to take flights that ideally departed at similar times (morning, evening, etc.) and, if possible, take flights that departed in similar seasons, all on a large set of flights to eliminate outliers.

The second sub-operation 58 is the determination D_E_S_ES of at least one estimated score element belonging to the group including:
the ratio of the amount of equivalent carbon dioxide associated with at least one persistent contrail of the flight to the total amount of carbon dioxide from the CO₂ emissions of the flight, this ratio, called “Ratio contrail/CO₂”, reflecting the relative importance of contrails compared to the direct emissions of the flight. Such a ratio is typically the most used to estimate the impact of a flight in terms of non-CO₂ effect, but may nevertheless lack detail for decision-making on mitigation actions, as there is no information on the temporality of contrails or their distribution.
the ratio of the distance over which at least one persistent contrail of the flight is likely to form to the total distance likely to be covered during the flight, such a ratio, called “Ratio contrail distance,” allowing comparison of the distance of persistent contrails to the total distance covered by the considered flight, a high value of this ratio implying that the considered flight generates persistent contrails over a large part of its trajectory (notably over at least half), and given that sustainable aviation fuel SAF is mixed with conventional fuel and potentially in different tanks, if optimization is carried out with this ratio, we will have some assurance that SAF has indeed been used to reduce non-CO₂ effects;
an estimated score element obtained from the function representative of the climate impact, over time, along the trajectory of the flight, of at least one persistent contrail likely to form during the flight using the amplitude and timing of impact peaks represented via the function, notably called via the aforementioned CoCip tool “Contrail Impact over time”, this score element being calculated using a temporal scoring function that takes into account the amplitude and timing of impact peaks. This score element allows the temporal evolutions of contrails to be taken into account, notably for planned mitigation. In the case of a long-haul flight generating significant contrails at the end of the trajectory, the evolution of the weather concerning the moment when the allocation is made may lead to a situation where the atmospheric situation has changed and no contrail is generated. A scoring function thus putting a higher score on contrails occurring at the beginning of the flight and with the highest amplitude is thus likely to be considered.

When the score element is an estimated score element obtained from the function representative of the climate impact, over time, along the trajectory of the flight, of at least one persistent contrail likely to form during the flight using the amplitude and timing of impact peaks represented via the function, likely to be called “Contrail Impact over time score”, such a score element is likely to be represented by the following equation where the value of the score element is normalized to keep consistent values concerning the other aforementioned score elements “Ratio contrail/CO₂” and “Ratio contrail distance”:

$$Normalized “ Contrail Impact over time score ” = \frac{{\sum }_{i = 1}^{n} \frac{{A}_{i}}{{t}_{i}}}{{\sum }_{i = 1}^{n} \vert {A}_{i} \vert}$$

with Aᵢ being the amplitude of a peak i of the function; tᵢ being the instant when the peak i occurs, and n the number of peaks of the function.

For example, for a flight likely to consume 4.5 tons of fuel over a distance of 1200 km, for which an impact in CO_{2eq} due to persistent contrails of 3 tons with the GWP100 metric would have been estimated and which would be likely to generate contrails over 100 km, all in three peaks at different time horizons, for example at 5% of the flight, 30% of the flight, and 80% of the flight and in different amplitudes 70%, 20%, 10% respectively, the score element “Ratio contrail/CO₂” would have a normalized value equal to 0.21, the score element “Ratio contrail distance” would have a normalized value equal to 0.1 and the score element “Contrail Impact over time score” would have a value equal to 0.44.

The third sub-operation 60 is implemented in case of determining at least two estimated score elements, and corresponds to (i.e., is) the combination according to a predetermined rule of the at least two estimated score elements to obtain the estimated score.

Note that the type of determination implemented during sub-operation 56 makes certain score elements not calculable. Indeed, if the use of the “location-based” model allows the three types of score elements “Ratio contrail/CO2”, “Ratio contrail distance” and “Contrail Impact over time score” to be calculated, it is not possible to do so using only historical data of similar past flights, so that in the case where these latter would be used, then the only calculable score element corresponds to the “Ratio contrail/CO2” (i.e., the ratio between CO2eq and CO2), and would be the only estimated score element then used for the next operation 62 as parameter Bj of the considered flight j to proceed with the allocation, as such, as described later.

According to another unrepresented implementation, operations 56, 58, 60 are implemented outside the electronic device for allocating sustainable aviation fuel to a plurality of flights planned over a predetermined time interval, according to the present invention (i.e., by an entity external to the device), and in this case, the electronic device for allocating sustainable aviation fuel directly obtains the estimated score calculated externally.

Then, the method 50 according to the present invention includes an operation 62, implemented from the set of estimated scores of each flight of the plurality of flights, to determine the allocation A of sustainable aviation fuel, associated with the maximum reduction of the estimated climate impact of the totality of flights of the plurality, the allocation allocating to each flight an elementary quantity of sustainable aviation fuel to be used during the flight.

Optionally, the determination of the allocation of sustainable aviation fuel uses linear programming optimization with an objective of maximizing the reduction of the climate impact of the totality of flights of the plurality, and respecting at least one predetermined constraint of availability and use of sustainable aviation fuel.

In other words, operation 62 aims to propose a SAF allocation that optimizes the reduction of the global climate impact of flights, taking into account various climate criteria and logistical constraints.

This problem is modeled in the form of a linear programming problem, with an objective of maximizing the reduction of the climate impact while respecting the imposed constraint(s), and is likely to be formalized by maximizing Σⱼ Bⱼ*xⱼ, with xⱼ being the quantity of SAF allocated to each flight j (this quantity may be zero, i.e., for some flights there is no SAF allocated), Bⱼ being the score associated with each flight at the end of sub-operation 60 representing the potential for climate impact reduction for each flight j considering that the closer Bⱼ is to 1, the more this flight has a potential for climate impact reduction when allocated sustainable aviation fuel SAF (note that, even in some cases, this score may be greater than 1 if the effects due to persistent contrails are greater than CO₂ emissions.

According to this optional complement, the at least one constraint belongs to the group including at least the following three constraints:
the sum of the elementary quantities of sustainable aviation fuel allocated respectively to each flight of the plurality is less than or equal to the total quantity of sustainable aviation fuel available for the plurality, as illustrated by the following equation: Σᵢxᵢ≤N, with N being the total quantity of SAF available for allocation;
for each flight to which an elementary quantity of sustainable aviation fuel is allocated, the percentage of the elementary quantity relative to the total quantity of fuel required for the flight is less than or equal to a predetermined percentage value, as illustrated by the following equation: ∀i,

$$\frac{{x}_{i}}{{\overline{x}}_{i} + {x}_{i}} \leq M ,$$

with M being the percentage of SAF that a flight may have at most (today this value is 50%);
the sum of the elementary quantities of sustainable aviation fuel allocated respectively to each flight of a set of flights of the plurality associated with the same departure airport is less than or equal to the total quantity of sustainable aviation fuel available at the departure airport for the set of flights, as illustrated by the following equation: ∀_{k,l},δ_{{y}_{ₖ}_{=1}}=δ_{{l=1}}, with y representative of the presence of SAF in (k,l) respectively representative of the pair (flight, airport) and the δ Kronecker delta.

To solve such a linear programming problem, various solvers are likely to be used to arrive at an allocation proposal, for example, the PuLP solver in Python, or alternatively CPLEX® (from IBM ILOG), Gurobi in Python, etc., capable of providing for the considered plurality of flights the quantity of sustainable aviation fuel SAF that should be allocated to maximize the reduction of climate impact.

It should be noted that this allocation (i.e., mitigation) method could also be associated with mitigation by flight level, namely, for example, that an aircraft with very few constraints imposed by Air Traffic Control ATC could be less prioritized for a SAF allocation, a simple and inexpensive mitigation means being then already available, namely the change of Flight Level FL in this case.

In summary, in this case, an additional type of constraint would be taken into account, and an aircraft, for a considered flight, would benefit from a specific SAF allocation if: the departure airport has SAF in a measurable quantity, the city pair (i.e., the pair coupling two cities, namely the departure city and the arrival city of the considered flight), and the considered aircraft are a source of “big hits” flights, namely a flight whose quantity in terms of CO₂ equivalent: CO_{2eq} (due to non-CO2 effects) is significant compared to CO2 (i.e., CO_{2eq}/CO₂ ratio at least equal to one), and if simple and less expensive mitigations of the “change of flight level FL” type are considered unnecessary, impossible, or too uncertain.

Then, optionally, as illustrated in dotted lines according to the embodiment shown in FIG. 2, the method 50 according to the present invention includes an optional operation 64 of restitution R of the fuel allocation determined at the end of operation 62.

Such restitution being, as previously indicated, carried out via a transmission (e.g., wireless radio communication), and/or via a display or even a sound restitution.

Then, optionally, as illustrated in dotted lines according to the embodiment shown in FIG. 2, the method 50 according to the present invention includes an optional operation 66 of use U, as such, of the allocation during the refueling with sustainable aviation fuel SAF of each aircraft associated with each flight of the plurality.

Optionally, the method 50 according to the present invention further includes a verification operation 68, after the effective implementation of the plurality of flights, of the effectiveness of the allocation.

According to a particular variant of this optional complement, the verification operation 68 includes the sub-operations 70, 72, 74, and 76 implemented after the arrival of the plurality of flights.

Sub-operation 70 is an operation of collecting C_D_E effective flight data acquiring, for each flight, at least data of at least one type belonging to the group including at least:
radar data of the performed trajectory;
raw flight data provided by a quick access recorder;
meteorological data representative of the weather conditions encountered during the flight.

Note that the meteorological data necessary for verification operation 68 are of similar types to those required during collection operation 52 and are also advantageously likely to be supplemented by meteorological data collected during the flight by aircraft sensors capable of capturing wind temperature data or even humidity, notably for aircraft composing the IAGOS (In-service Aircraft for a Global Observing System) fleet.

Sub-operation 72 is implemented using the collected effective data, the allocation, and the predetermined climate metric, and is an operation of obtaining O_S_EFF an effective score representative of the effective climate impact of each flight of the plurality of flights, the effective climate impact covering both the CO₂ emissions of the flight and the non-CO₂ effects associated with the flight performed using the sustainable aviation fuel allocated according to the allocation.

Sub-operation 74 is implemented using the set of effective scores of each flight of the plurality of flights and is an operation of determining D_R the effective reduction of climate impact obtained via the allocation.

Finally, sub-operation 76 is an operation of comparing COMP the effective reduction to the maximum estimated reduction during the determination 62 of the allocation, and in the presence of a discrepancy (greater than a predetermined threshold), also includes the restitution of the discrepancy notably via the optional restitution module 24 previously described.

In other words, according to verification operation 68, once the allocation determined at the end of operation 62, and the SAF allocated concretely to the different aircraft, it is possible a posteriori to verify that the allocation strategy has been beneficial from a climate point of view, for example by reducing the amount of CO_{2eq} emitted after the allocation versus the scenario without allocation.

To do this, we retrieve according to sub-operation 70 once again the flights carried out, this time using the data of a cooperative surveillance system for air traffic control (e.g., ADS-B Automatic dependent surveillance-broadcast) of the trajectory or possibly the raw flight data provided by a Quick Access Recorder QAR. The weather at the time of the performed flight is also retrieved and emission calculations are carried out to determine the amount of equivalent carbon dioxide CO_{2eq} emitted by each flight of the considered plurality of flights for the allocation.

To take into account the amount of sustainable aviation fuel SAF in the emission calculation, several known methods are likely to be used, using, for example, data associated with engines, notably related to non-volatile particles nvPM, emission index EI, etc., and modeling tools for the formation and evolution of contrails and cirrus, such as CoCip (Contrail Cirrus Prediction tool), to calculate the Radiative Forcing, then the amount of equivalent carbon dioxide CO_{2eq} associated with these flights, a simplified approach based on known coefficients and abacuses depending on the SAF mix (i.e., the proportion) in each flight is also likely to be applied. An interpolation for SAF values not existing in these known methods mentioned is, if necessary, also likely to be implemented during this verification operation 68.

According to this operation 68, via sub-operation 76, it is finally proposed to compare the set of emissions of the different flights and make a delta versus a credible alternative scenario, such as, for example, the scenario recently highlighted by the European Union with a new mandate for all European flights to integrate a minimum amount of SAF of a few percent (one to two percent).

Such a post-comparison 76 thus allows the allocation proposed according to the present invention to be compared to several nominal scenarios and a reduced impact to be ensured.

Such a verification operation 68 is also likely to be used to create consumption/use models of SAFs in flight in the case where an innovative fuel management system would allow non-uniform consumption of SAF during a flight.

The person skilled in the art will understand that the invention is not limited to the described embodiments, nor to the specific examples of the description, the embodiments and variants mentioned above being likely to be combined with each other to generate new embodiments of the invention.

In other words, the invention seeks notably to estimate and detect flights likely to generate contrails and to propose a realistic allocation of sustainable aviation fuel SAF for these flights based on multiple constraints (airport infrastructure, constraints associated with airlines, SAF not available, impossibility of avoiding contrail generation zones due to ATC traffic conditions, etc.).

The invention thus proposes to reduce the climate impact of aviation by relying on a better allocation of SAF based on calculations and estimates from climate, meteorological, and aircraft models.

1. A method for allocating sustainable aviation fuel to a plurality of flights planned over a predetermined time interval, the method being implemented by an electronic device, and comprising at least the following operations implemented prior to the departure of the plurality of flights:
collecting flight data acquiring, for each flight, at least a pair of data formed by information representative of the departure airport and information representative of the arrival airport of the flight;
obtaining, from the collected data and from a predetermined climate metric, an estimated score representative of the estimated climate impact of each flight of the plurality of flights, the estimated climate impact covering both the CO₂ emissions of the flight and the non-CO₂ effects associated with the flight, and the climate metric being likely to be selected in advance from a list comprising at least the following metrics: GWP20, GWP50, GWP100, ATR20, ATR50, ATR100, GTP20 or AGTP20, GTP50 or AGTP50, GTP100 or AGTP100, and EF or RF; and
determining, from the set of estimated scores of each flight of the plurality of flights, an allocation of sustainable aviation fuel, associated with the maximum reduction of the estimated climate impact of the totality of flights of the plurality, the allocation allocating to each flight an elementary quantity of sustainable aviation fuel to be used during the flight.

2. The method according to claim 1, wherein said collecting further acquires, for each flight, at least one element belonging to the group consisting of:
the type of aircraft operating the flight;
the engine of the aircraft operating the flight;
the planned departure time and day of the flight;
the trajectory and/or the planned flight plan for the flight; and
at least one forecasted weather data on the trajectory of the type belonging to the group consisting of:
humidity data;
temperature data; and
wind data.

3. The method according to claim 1, wherein said obtaining comprises successively:
determining at least one value belonging to the group consisting of:
the amount of carbon dioxide from the CO₂ emissions of the flight;
the amount of equivalent carbon dioxide associated with at least one persistent contrail of the flight;
the distance over which at least one persistent contrail of the flight is likely to form; and
a function representative of the climate impact over time along the trajectory of the flight of at least one persistent contrail likely to form during the flight;
further determining at least one estimated score element belonging to the group consisting of:
the ratio of the amount of equivalent carbon dioxide associated with at least one persistent contrail of the flight to the amount of carbon dioxide from the CO₂ emissions of the flight;
the ratio of the distance over which at least one persistent contrail of the flight is likely to form to the total distance likely to be covered during the flight; and
an estimated score element obtained from the function representative of the climate impact over time along the trajectory of the flight of at least one persistent contrail likely to form during the flight using the amplitude and timing of impact peaks represented via the function; and
in case said further determining determines at least two estimated score elements, combining according to a predetermined rule the at least two estimated score elements to obtain the estimated score.

4. The method according to claim 1, wherein said determining comprises using linear programming optimization with an objective of maximizing the reduction of the climate impact of the totality of flights of the plurality, and respecting at least one predetermined constraint of availability and use of sustainable aviation fuel.

5. The method according to claim 4, wherein said at least one constraint belongs to the group consisting of:
the sum of the elementary quantities of sustainable aviation fuel allocated respectively to each flight of the plurality is less than or equal to the total quantity of sustainable aviation fuel available for the plurality;
for each flight to which an elementary quantity of sustainable aviation fuel is allocated, the percentage of the elementary quantity relative to the total quantity of fuel required for the flight is less than or equal to a predetermined percentage value; and
the sum of the elementary quantities of sustainable aviation fuel allocated respectively to each flight of a set of flights of the plurality associated with the same departure airport is less than or equal to the total quantity of sustainable aviation fuel available at the departure airport for the set of flights.

6. The method according to claim 1 further comprising verifying, after the effective implementation of the plurality of flights, the effectiveness of the allocation, comprising the following sub-operations implemented after the arrival of the plurality of flights:
collecting effective flight data acquiring, for each flight, at least data of at least one type belonging to the group consisting of:
radar data of the performed trajectory;
raw flight data provided by a quick access recorder; and
meteorological data representative of the weather conditions encountered during the flight;
obtaining, from the collected effective data, from the allocation, and from the predetermined climate metric, an effective score representative of the effective climate impact of each flight of the plurality of flights, the effective climate impact covering both the CO₂ emissions of the flight and the non-CO₂ effects associated with the flight performed using the sustainable aviation fuel allocated according to the allocation;
determining, from the set of effective scores of each flight of the plurality of flights, the effective reduction of climate impact obtained via the allocation; and
comparing the effective reduction to the maximum estimated reduction during said determining an allocation, and in the presence of a discrepancy, restitution of the discrepancy.

7. A non-transitory computer-readable medium comprising instructions that, when executed by a computer, cause the computer to implement the method of claim 1.

8. An electronic device for allocating sustainable aviation fuel to a plurality of flights planned over a predetermined time interval, comprising:
a collector collecting flight data and acquiring, for each flight, at least a pair of data formed by information representative of the departure airport and information representative of the arrival airport of the flight;
an obtainer obtaining, from the collected data and from a predetermined climate metric, a score representative of the climate impact of each flight of the plurality of flights, the climate impact covering both the CO₂ emissions of the flight and the non-CO₂ effects associated with the flight, and the climate metric being likely to be selected in advance from a list consisting of: GWP20, GWP50, GWP100, ATR20, ATR50, ATR100, GTP20 or AGTP20, GTP50 or AGTP50, GTP100 or AGTP100, and EF or RF; and
a determiner determining, from the set of scores of each flight of the plurality of flights, an allocation of sustainable aviation fuel associated with the maximum reduction of the climate impact of the totality of flights of the plurality, the allocation allocating to each flight an elementary quantity of sustainable aviation fuel to be used during the flight.
